(19) United States
(12) Patent Application Publication
(10) Pub. No.: US 2016/0148482 A1
(43) Pub. Date: May 26, 2016

(54) Immersion alert bracelet

(71) Applicant: Norma L. Branch, Mesa, AZ (US)

(72) Inventor: Norma L. Branch, Mesa, AZ (US)

(21) Appl. No.: 14/949,700

(22) Filed: Nov. 23, 2015

Related U.S. Application Data
(60) Provisional application No. 62/082,934, filed on Nov. 21, 2014.

(51) Int. Cl. G08B 21/08

(52) U.S. Cl. CPC G08B 21/088

(57) ABSTRACT

An immersion alert bracelet alerts the user when the bracelet is submerged in water. The bracelet is worn on the wrist or ankle of a small child or disabled adult, when near a body of water that presents a drowning risk. The bracelet contains a sensor which activates the bracelet if the bracelet becomes submerged. Upon being activated, the bracelet transmits a wireless underwater alert to a speaker base. The speaker base, upon receiving the underwater alert from the bracelet, sounds an audible alert to the adult user, indicating that the child or disabled adult has fallen into the water.

### CROSS-REFERENCE TO RELATED APPLICATIONS

This Application claims the benefit of U.S. Provisional Application No. 62/082,934, filed Nov. 21, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to child safety devices and in particular to an immersion alert bracelet. Drowning is one of the most common causes of death during childhood. The thought of a child falling into a body of water is one of the worst and most common causes of anxiety for parents. The caretakers of elderly and disabled adults, and even pet owners, may also be concerned by similar risks. In some cases, a home located close to a river or lake, or equipped with a swimming pool, may cause concern. In other cases, a boat excursion may create a risk. An immersion alert bracelet, which transmits a wireless underwater alert to a speaker base when submerged, would cause the speaker base to sound an audible alert to a responsible adult, and would resolve this problem.

### SUMMARY OF THE INVENTION

Accordingly, the invention is directed to an immersion alert bracelet. The bracelet is worn on the wrist or ankle of a small child or disabled adult, when near a body of water that presents a drowning risk. The bracelet contains a sensor which activates the bracelet if the bracelet becomes submerged. Upon being activated, the bracelet transmits a wireless underwater alert to a speaker base. The speaker base, upon receiving the underwater alert from the bracelet, sounds an audible alert to the adult user, indicating that the child or disabled adult has fallen into the water.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 is a side view of the bracelet component of the first exemplary embodiment, displaying the bracelet 10.

FIG. 2 is a front view of the bracelet component of the first exemplary embodiment, displaying the bracelet 10, and the buckle 11.

FIG. 3 is a front view of the speaker base component of the first exemplary embodiment, displaying the speaker base 12, the speaker 13, the power control 14, the alert light 14A, and the volume control 14B.

FIG. 4 is a front view of the mobile recharging cable 15.

FIG. 5 is a front view of the house current recharging cable 16.

FIG. 6 is a front view of the hydrophone 17 with connecting cable 18 and plug 19.

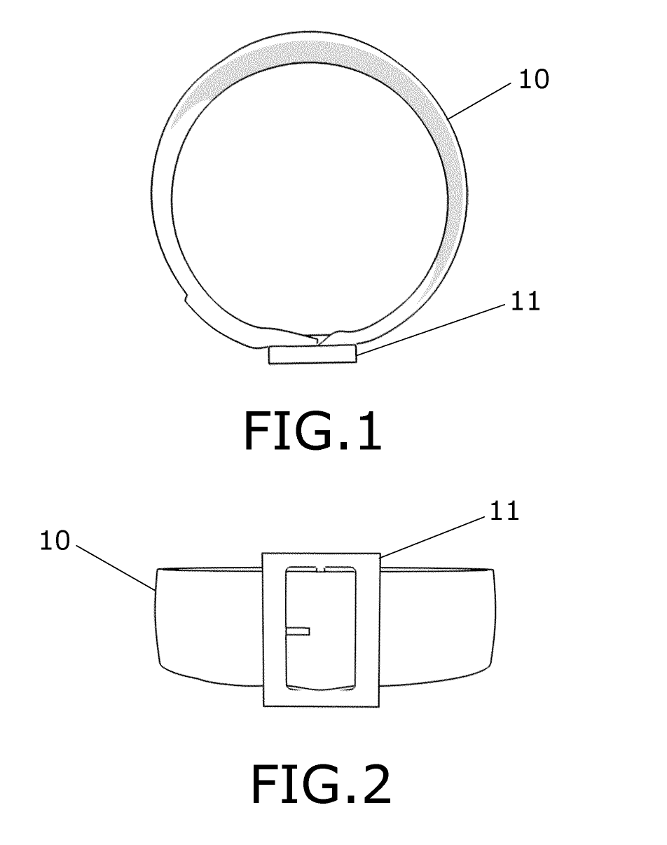

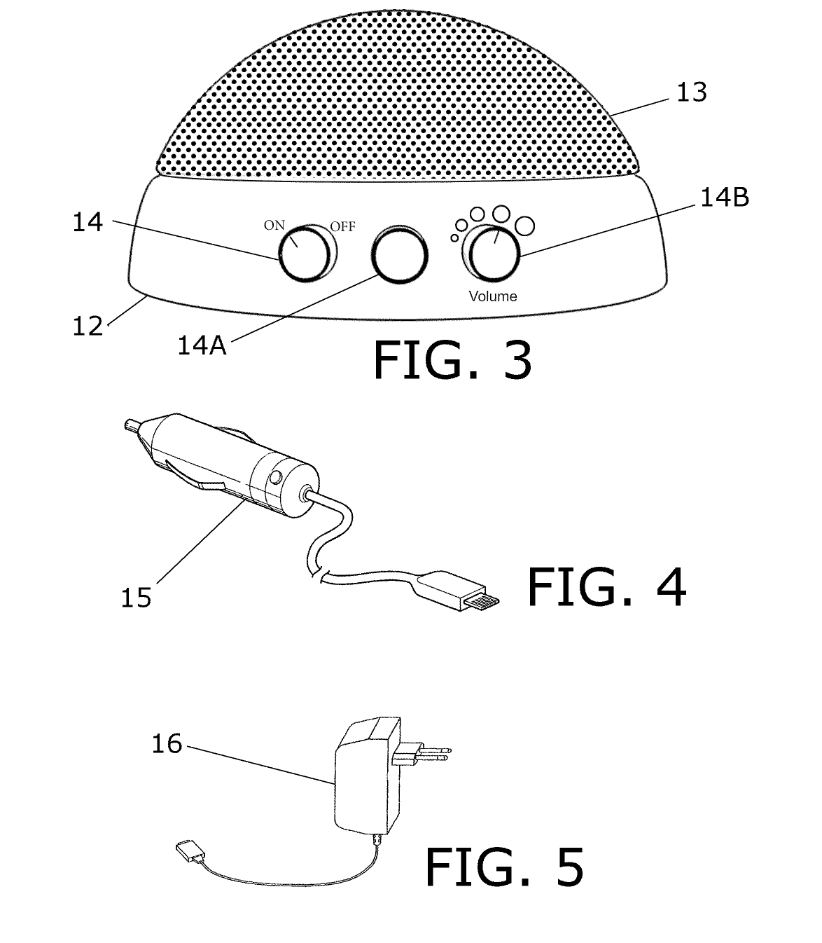

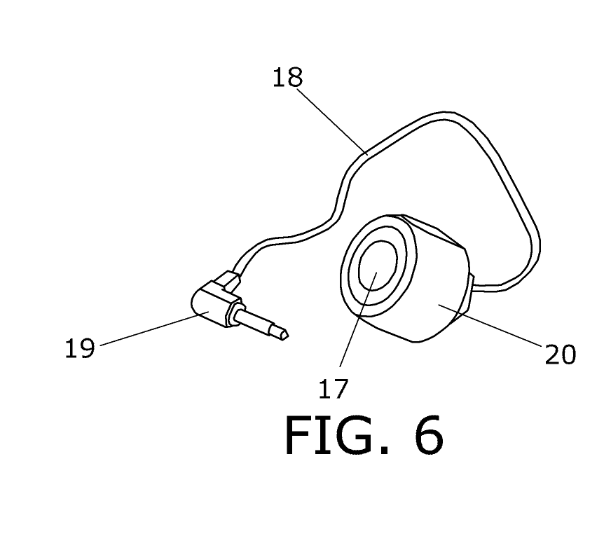

### DETAILED DESCRIPTION OF THE INVENTION

Referring now to the invention in more detail, the invention is directed to an immersion alert bracelet 10.

It is to be understood that while the invention is intended for use with one or more small children or disabled adults, this is not intended as a limitation. With suitable modifications or with no modifications at all, the invention may be used with commercial fishing boat crewmen, cruise ship passengers, cargo ship crewmen, sailors and other military personnel, herds of livestock, and any other persons or animals who are at risk of drowning due to submersion in a body of water.

The first exemplary embodiment comprised of two components: one or more immersion alert bracelets 10 and a speaker base 12 with a hydrophone 17 which is removably connected to the rear surface of the speaker base 12 via a cable 18 and audio plug 19. Each bracelet 10 is intended for wear on the wrist or ankle of a young child, a disabled adult, or some other protected person who is at risk of drowning due to submersion in water.

The bracelet 10 is provided in a broad range of sizes, and is preferably secured with a buckle 11. Preferably, the bracelet 10 is available separately and is provided in a broad range of bright colors and patterns likely to interest a young child to wear including glow-in-the-dark, and is also available in more neutral colors such as black, gray, brown, and navy blue. An alternate embodiment, wherein the bracelet 10 is provided in the form of a collar for a pet, is contemplated.

The speaker base 12 is generally hemispheric in shape, with the upper half comprising a large, rounded speaker 13 and a solid band of rigid material around the lower half, providing on/off and volume control 14, an alert light 14A, and a volume control 14B.

The bracelet 10 contains a sensor which activates the bracelet 10 if the bracelet 10 becomes submerged. The bracelet 10 is preferably powered by one or more replaceable batteries, and provides a small underwater speaker which, when activated, transmits a wireless underwater alert to the speaker base 12.

Preferably, the underwater alert is comprised of a series of short bursts of high pitched sound, or “pings.” Preferably, each ping is of a predetermined length, such as 0.1 second. Preferably, the interval between pings is of a predetermined length, such as 1.9 seconds.

The speaker base 12 receives the underwater signal via the hydrophone 17, which is lowered into the water for active use. The identifying characteristics of the length of the ping, the interval between pings, and the high-pitched frequency of the pings are recognized by the speaker base 12 as an underwater signal from a bracelet 10. This causes the speaker base 12 to immediately sound a loud audible alert from the speaker 13, and also causes the alert light 14A to flash on and off.

The speaker base 12 is capable of distinguishing the underwater alert from other sounds, such as the engine noise and wake created by a motorboat. The speaker base 12 is preferably powered by a rechargeable battery. A removable mobile recharging cable 15, which may be plugged into the cigarette lighter or other auxiliary power port of a vehicle, and a removable house current recharging cable 16, which may be plugged into any standard three-pronged wall outlet, are provided. Optionally, the hydrophone 17 may provide a small hydrodynamic float 20, which enables the responsible adult user to tow the hydrophone behind or adjacent to a motorboat wherein the protected child or disabled adult is riding.

To use the first exemplary embodiment, the responsible adult user affixes the bracelet 10 on the wrist or ankle of the protected person. The user then places the speaker base 12 near the body of water and activates the speaker base with the controls 14. The adult user then lowers the hydrophone into the body of water. If the protected person falls into the water, an audible alert is sounded from the speaker and the alert light 14A flashes. The responsible adult user may then take the appropriate action to secure the safety of the protected person.

The bracelet 10 is preferably manufactured from a flexible, durable fabric which is water resistant, such as nylon. The buckle 11 is preferably manufactured from a rigid, durable material which is lightweight, such as plastic. The speaker base 12 and the hydrophone 17 are preferably manufactured from rigid, durable materials such as steel, aluminum alloy, plastic, and copper alloy. The mobile recharging cable 15, the house current recharging cable 16, and the hydrophone cable 18 are preferably manufactured from braided copper alloy wire sheathed in plastic, terminating in plugs and jacks 19 which are preferably manufactured from rigid, durable materials such as steel, plastic, and copper alloy.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An immersion alert bracelet, comprising:
a. at least one bracelet;
b. said bracelet having a means of attachment;
c. said bracelet containing a sensor;
d. said sensor being configured to activate when said bracelet become submerged under water;
e. a speaker base;
f. said speaker having controls and a speaker;
g. a hydrophone; and
h. said hydrophone being attached to said speaker base via a cable and audio jack.
